(19) United States
(12) Patent Application Publication
(10) Pub. No.: US 2017/0308397 A1
(43) Pub. Date: Oct. 26, 2017

(54) METHOD AND APPARATUS FOR MANAGING TASK OF INSTANT MESSAGING APPLICATION

(71) Applicant: Beijing Xiaomi Mobile Software Co., Ltd., Beijing (CN)

(72) Inventors: Zhenzhou LU, Beijing (CN); Yin ZHU, Beijing (CN); Fan BU, Beijing (CN)

(21) Appl. No.: 15/336,823

(22) Filed: Oct. 28, 2016

(30) Foreign Application Priority Data
Apr. 21, 2016 (CN) 201610252256.0

(51) Int. Cl. G06F 9/48

(52) U.S. Cl. CPC G06F 9/4812

(57) ABSTRACT

A method and an apparatus for managing a task of an instant messaging application are provided. The method includes: during a process of executing a first function task of the instant messaging application, if an instruction for triggering a second function of the instant messaging application is received, switching the first function task to background; creating a first task tab; creating a second function task; and after the second function task is created, pulling up the first function task to switch the first function task to foreground if a designed operation is received based on the first task tab.

### CROSS REFERENCE TO RELATED APPLICATION

This application is based upon and claims a priority to Chinese Patent Application Serial No. 201610252256.0, filed with the State Intellectual Property Office of P. R. China on Apr. 21, 2016, the entire contents of which are incorporated herein by reference.

### FIELD

The present disclosure relates to the field of Internet, and more particularly to a method and an apparatus for managing a task of an instant messaging application.

### BACKGROUND

With the development of Internet, phones, smart watches and such intelligent terminals have become increasingly popular, and more applications are installed on the intelligent terminals. There are typically a plurality of functions included in one application. Take the instant messaging application as an example: the instant messaging application may include instant messaging function, webpage surfing function, paying function and the like. If the instant messaging application is in use, it may execute different function tasks by triggering the different functions thereof.

Typically, if it is detected that an operation of triggering a second function is sent by a user during a process that the instant messaging application executes a first function task, the instant messaging application may exit the first function task and then create the second function task, and then execute the second function task. The first function task may be recreated and then re-executed again if the execution of the second function task is finished and it is detected that an operation of triggering the first function is sent by the user.

### SUMMARY

According to a first aspect of embodiments of the present disclosure, a method for managing a task of an instant messaging application is provided. The method includes: switching the first function task to background if an instruction for triggering a second function of the instant messaging application is received during a process of executing a first function task of the instant messaging application; creating a first task tab configured to pull up the first function task; creating a second function task; and pulling up the first function task to switch the first function task to foreground if a designed operation is received based on the first task tab after creating the second function task.

According to a second aspect of embodiments of the present disclosure, a device for managing a task of an instant messaging application is provided. The device includes a processor; and a memory, configured to store instructions executable by the processor. The processor is configured to: switch the first function task to background if an instruction for triggering a second function of the instant messaging application is received during a process of executing a first function task of the instant messaging application; create a first task tab configured to pull up the first function task; create a second function task; and pull up the first function task to switch the first function task to foreground if a designed operation is received based on the first task tab after creating the second function task.

According to a third aspect of embodiments of the present disclosure, a non-transitory computer-readable storage medium is provided. The non-transitory computer-readable storage medium has stored therein instructions that, when executed by a processor of a terminal, causes the terminal to perform a method for managing a task of an instant messaging application. The method includes: switching the first function task to background if an instruction for triggering a second function of the instant messaging application is received during a process of executing a first function task of the instant messaging application; creating a first task tab configured to pull up the first function task; creating a second function task; and pulling up the first function task to switch the first function task to foreground if a designed operation is received based on the first task tab after creating the second function task.

It is to be understood that both the foregoing general description and the following detailed description are exemplary and explanatory only and are not restrictive of the present disclosure

### BRIEF DESCRIPTION OF THE DRAWINGS

The accompanying drawings are included in the specification and are parts of the specification, which are satisfied to the embodiments of the present invention and are used for describing the principles of the present invention, together with the specification.

FIG. 1 is a flow chart showing a method for managing a task of an instant messaging application according to an exemplary embodiment;

FIG. 2 is a flow chart showing another method for managing a task of an instant messaging application according to an exemplary embodiment;

FIG. 3 is a schematic diagram illustrating a displaying interface of a webpage surfing task according to an exemplary embodiment;

FIG. 4 is a schematic diagram illustrating another displaying interface of a webpage surfing task according to an exemplary embodiment;

FIG. 5 is a schematic diagram illustrating still another displaying interface of a webpage surfing task according to an exemplary embodiment;

FIG. 6 is a block diagram illustrating an apparatus for managing a task of an instant messaging application according to an exemplary embodiment;

FIG. 7 is a block diagram illustrating another device for managing a task of an instant messaging application according to an exemplary embodiment;

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of apparatuses and methods consistent with aspects related to the invention as recited in the appended claims.

Before explaining and describing the embodiments of the present disclosure in detail, application scenarios of the embodiments of the present disclosure may be illustrated. As the instant messaging application installed on the intelligent terminal may typically include instant messaging function, webpage surfing function, paying function, and such functions, the intelligent terminal may execute different function tasks if different functions of the instant messaging application are triggered. Typically, during a process that the intelligent terminal executes the first function task, if an operation that a user triggers the second function is detected, the first function task needs to be exited before the second function task is created and executed. Then, when an operation that the user triggers the first function is detected again, if execution of the second function task is completed, the first function task needs to be recreated and re-executed again. If the second function task is being executed, the first function task cannot be created and executed, or the second function task needs to be exited to create and execute the first function task. As such, the efficiency of the intelligent terminal is low. Therefore, the embodiments of the present disclosure provide a method for managing a task of an instant messaging application, which may improve the operation efficiency of the instant messaging application and the operation efficiency of the intelligent terminal.

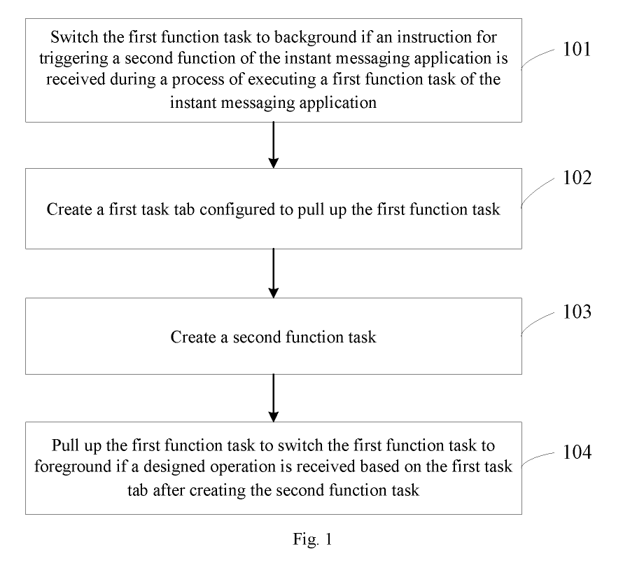

FIG. 1 is a flow chart showing a method for managing a task of an instant messaging application according to an exemplary embodiment. Referring to FIG. 1, the method for managing a task of an instant messaging application is applied in an intelligent terminal, and the method includes followings.

In 101, during a process of executing a first function task of the instant messaging application, the first function task is switched to background if an instruction for triggering a second function of the instant messaging application is received.

In 102, a first task tab configured to pull up the first function task is created.

In 103, a second function task is created.

In 104, after the second function task is created, the first function task is pulled up to switch the first function task to foreground if a designed operation is received based on the first task tab.

In the embodiment of the present disclosure, when executing the first function task of the instant messaging application and receiving the instruction for triggering the second function of the instant messaging application, the intelligent terminal may switch the first function task to background, and may also store the status information of the first function task thereafter. And then, in order to pull up the first function task, the intelligent terminal may also create the first task tab. In addition, the intelligent terminal may create the second function task. Therefore, it may not only ensure that the first function task is stored precisely before the second function task is created, but also ensure that the second function task is created and executed, thereby improving the efficiency of the intelligent terminal executing a plurality of function tasks at the same time. After creating the second function task, the intelligent terminal may pull up the first function task to switch the first function task to foreground if receiving the designed operation based on the first task tab. The embodiments of the present disclosure may pull up the first function after switching the first function task to background and creating the second function task, and continue the execution of the first function task, thereby improving the efficiency for managing the function tasks of the instant messaging application.

In another embodiment of the present disclosure, after creating the first task tab, the method further includes: hiding the first task tab during a process of executing the second function task; and displaying the first task tab if a predetermined operation is received.

In another embodiment of the present disclosure, the method further includes: if a task tab managing instruction is received based on a plurality of task tabs, managing the plurality of task tabs, and the plurality of task tabs is task tabs that have been created for a plurality of function tasks of the instant messaging application in current.

In another embodiment of the present disclosure, during the process of executing the first function task of the instant messaging application, if the instruction for triggering the second function of the instant messaging application is received, switching the first function task to background. After the switch, the method further includes: storing status information of the first function task, the status information of the first function task at least includes executing progress of the first function task.

In another embodiment of the present disclosure, after the second function task is created, if the designed operation is received based on the first task tab, the first function task is pulled up to switch the first function task to foreground, and the method includes: after the second function task is created, reading the status information of the first function task if the designed operation is received based on the first task tab; and pulling up the first function task to switch the first function task to foreground according to the status information of the first function task.

The above embodiments may be combined in any manners, which may be not elaborated herein.

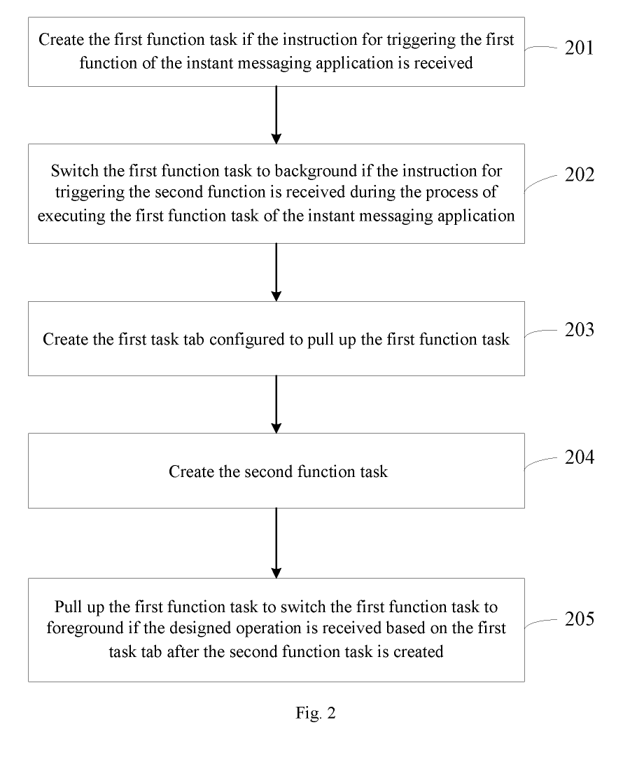

FIG. 2 is a flow chart showing a method for managing a task of an instant messaging application according to an exemplary embodiment. Referring to FIG. 2, the method for managing a task of an instant messaging application is applied in the intelligent terminal, and the method includes followings.

In 201, the first function task is created if the instruction for triggering the first function of the instant messaging application is received.

The instant messaging application installed on the intelligent terminal may include instant messaging function, webpage surfing function, paying function and the like. Therefore, if the intelligent terminal receives the instruction for triggering the first function of the instant messaging application, the first function task may be created and then may be executed.

It should be illustrated that, the intelligent terminal may be a smart phone, a smart watch, smart glasses, a VR (Virtual Reality) terminal, and such intelligent terminals. Certainly, the intelligent terminal may also be other terminal on which the instant messaging application is installed, which is not specifically limited in the embodiments of the present disclosure.

It should be illustrated that, the first function may be any one of a plurality of functions included in the instant messaging application. The first function task may be a task corresponding to the first function.

Furthermore, the instruction for triggering the first function may be triggered by the user via executing a specific operation. The specific operation may be a clicking operation, a sliding operation, a speech operation, a shaking operation, and the like. Certainly, in the practical applications, the specific operation may be other operations, which is not specifically limited in the embodiments of the present disclosure.

In 202, during the process of executing the first function task of the instant messaging application, if the instruction for triggering the second function is received, the first function task is switched to background.

As there are the plurality of functions included in the instant messaging application installed on the intelligent terminal, the user may desire to use at least two functions of the plurality of functions in the same period of time. For instance, the user desires to surf webpages during the process of instant messaging. Therefore, in order to fully satisfy the demands of the user, the intelligent terminal may also receive the instruction for triggering the second function of the instant messaging application during the process of executing the first function task of the instant messaging application. Further, in order to improve the operation efficiency of the intelligent terminal, the intelligent terminal may switch the first function task to background if receiving the instruction for triggering the second function of the instant messaging application.

It should be illustrated that, the instruction for triggering the second function may be triggered by the user via executing the specific operation.

It also should be illustrated that, the second function may be any one function of the instant messaging application.

For instance, during the process of executing the webpage surfing task, if the instruction for triggering the instant messaging function of the instant messaging application is received, the intelligent terminal may switch the webpage surfing task to background.

Furthermore, after the first function task is switched to background, in order to completely store information related to the first function task and improve the efficiency of pulling up the first function task and the efficiency of managing the function tasks of the instant messaging application, the intelligent terminal, during the process of executing the first function task of the instant messaging application, may also store the status information of the first function task if receiving the instruction for triggering the second function. The status information of the first function task may at least include executing progress of the first function task.

The status information of the first function task is configured to illustrate the status of the first function task if the first function task of the instant messaging application is switched to background.

In should be illustrated that, the executing progress of the first function task may include inputting progress of an input field, playing progress of a multi-media file (including audio, video, and the like), display location of the first function task located in the display region of the intelligent terminal, and such information. Certainly, in the practical applications, the executing progress of the first function task may include other information, which is not specifically limited in the embodiments of the present disclosure.

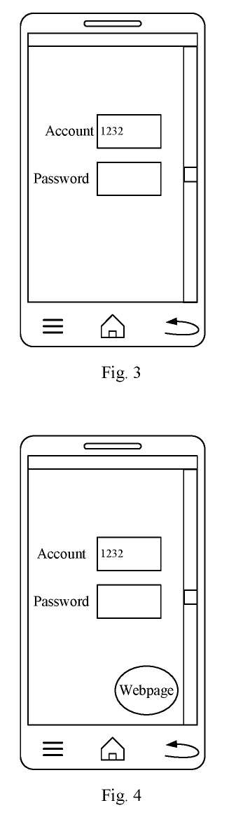

For instance, when the intelligent terminal switches the webpage surfing task to background, the display region of the intelligent terminal is located at 50 percent of webpage content of the webpage surfing task. As shown in FIG. 3, the display region includes a word “account,” an account input field, a word “password” and a password input field. Herein, there are the account input field with “1232” and the password input field with nothing. Therefore, the intelligent terminal may store the executing progress of the webpage surfing task as 50 percent of webpage location and “1232” in the account input field.

Furthermore, in order to improve the accuracy for pulling up the first function task, when storing the status information of the first function task, the intelligent terminal may store both a task identifier and the status information of the first function task into a corresponding relationship between the task identifier and the status information.

The task identifier may be a task name of the first function task, a process ID (identification) of the first function task in the intelligent terminal, a thread ID, or the like. Certainly, in the practical applications, the task identifier may be other information that may enable to identify the first function task, which is not specifically limited in the embodiments of the present disclosure.

It should be illustrated that, if the intelligent terminal executes the first function task by occupying a process, the task identifier may be the process ID; if the intelligent terminal executes the first function task by occupying a thread, the task identifier may be the thread ID.

For instance, if the intelligent terminal stores the status information of the webpage surfing task, the task identifier of the webpage surfing task may be the task name with “webpage surfing,” and the status information may be status information 1. The intelligent terminal may store “webpage surfing” and the status information 1 into the corresponding relationship between the task identifier and the status information, as shown in Table 1.

TABLE 1

| task identifier | status information |
|---|---|
| webpage surfing | status information 1 |
| instant messaging | status information 2 |
| paying | status information 3 |
| . . . | . . . |

It should be illustrated that, the corresponding relationship between the task identifier and the status information shown in Table 1 is merely taken as an example to illustrate the embodiments of the present disclosure, but Table 1 is not limitation of the embodiments of the present disclosure.

It should be also illustrated that, the status information of the first function task may include creation time of the first function task, occupied resources in the intelligent terminal, and other information, which is not specifically limited in the embodiments of the present disclosure.

In 203, the first task tab configured to pull up the first function task is created.

After the intelligent terminal switches the first function task to background, as the first function task may need to be pulled up and then may continue to be executed, the intelligent terminal may create the first task tab to facilitate pulling up the first function task.

It should be illustrated that, to facilitate pulling up the first function task for the intelligent terminal according to the first task tab, the intelligent terminal may display the first task tab in foreground.

It should be also illustrated that if the intelligent terminal displays the first task tab in foreground, the first task tab may be displayed in any location in the display region of the intelligent terminal, which is not specifically limited in the present disclosure.

Furthermore, if the intelligent terminal displays the first task tab in foreground, part of the display region of the intelligent terminal may be occupied, thereby decreasing the display effect of the intelligent terminal. Therefore, the intelligent terminal may display the first task tab in a translucent way, or may hide the first task tab. The first task tab may be displayed if the predetermined operation is received.

It should be illustrated that, the predetermined operation may be a clicking operation, a sliding operation, a speech operation, a shaking operation and the like. Certainly, in the practical applications, the predetermined operation may be other operations, which is not specifically limited in the embodiments of the present disclosure.

In addition, the intelligent terminal may create the first task tab at any time before the first function task has been switched to background, which is not specifically limited in the embodiments of the present disclosure.

In 204, the second function task is created.

If the intelligent terminal receives the instruction for triggering the second function of the instant messaging application, the first function task is switched to background and the first task tab is created. Then, the second function task is created after the first function task is protected.

Furthermore, as the described above, the first task tab may be displayed in foreground after the intelligent terminal switches the first function task to background. Therefore, the intelligent terminal may display the first task tab in foreground during the process of creating and executing the second function task, i.e. display both the first task tab and the second function task that is being executed currently in a same display region of the intelligent terminal at the same time.

If the intelligent terminal displays both the first task tab and the second function task that is being executed currently in the same display region, it may display the first task tab in an opaque way or in a translucent way, and also may hide the first task tab. The first task tab may be displayed if the predetermined operation is received.

It should be illustrated that, if the intelligent terminal displays the first task tab in the translucent way or hides the first task tab, it displays the first task tab when the predetermined operation is received, so that disturbance of the first task tab is avoided when the intelligent terminal generates and executes the second function task, thereby improving the executing efficiency of the intelligent terminal.

For instance, as shown in FIG. 4, during the process of creating and executing the instant messaging task, the task tab with “webpage” may be displayed in a region where the instant messaging task is displayed at the same time.

It should be illustrated that, if the intelligent terminal includes a plurality of display screens, the intelligent terminal may display the first task tab and the second function task that is being executed currently respectively on the plurality of display screens. The intelligent terminal may also display the first task tab and the second function task that is being executed currently on a unified display region of any one display screen of the plurality of display screens, which is not specifically limited in the embodiments of the present disclosure.

In 205, after the second function task is created, the first function task is pulled up to switch the first function task to foreground if the designed operation is received based on the first task tab.

As the first function task has been switched to background before the intelligent terminal creates the second function task, the user may desire to continue to execute the first function task. Therefore, if the designed operation is received based on the first task tab, the first function task is pulled up to switch the first function task to foreground and then continue to be executed.

In should be illustrate that, the designed operation may be a clicking operation, a sliding operation, a speech operation, a shaking operation, and the like. Certainly, in the practical applications, the designed operation may be other operations, which is not specifically limited in the embodiments of the present disclosure.

Furthermore, in order to ensure that the status of the first function task that is being pulled up is same with the status of the first function task that is being switched to background and to improve the efficiency and accuracy of pulling up the first function task, the intelligent terminal, after creating the second function task, may read the status information of the first function task if receiving the designed operation based on the first task tab, and then may pull up the first function task to switch the first function task to foreground according to the status information of the first function task.

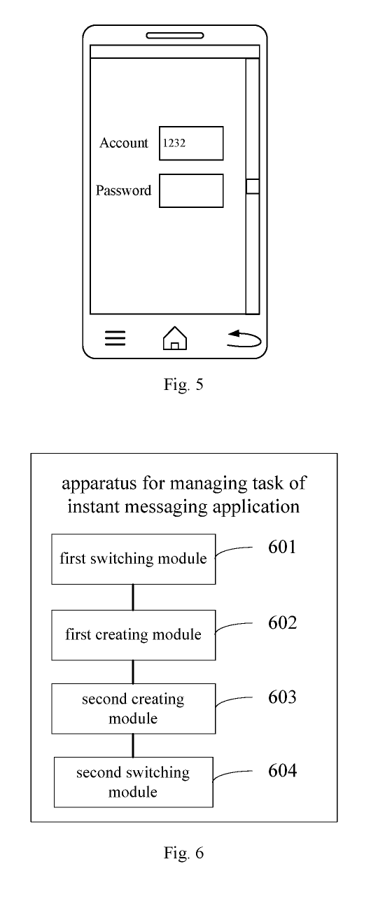

For instance, the status information of the webpage surfing task read by the intelligent terminal is status information 1. Status information 1 includes the executing progress of the webpage surfing task with 50 percent of webpage location and the account input box with “1232.” Therefore, the intelligent terminal may pull up the webpage surfing task according to the executing progress of the webpage surfing task included in status information 1. As shown in FIG. 5, 50 percent of webpage location of the webpage surfing task and the account input box with “1232” are displayed, which may ensure that the status of the webpage surfing task that is being pulled up is same with the status of the webpage surfing task that is being switched to background.

Furthermore, after the intelligent terminal creates the second function task, when the designed operation is received based on the first task tab, the execution of the second function task may be completed or not. Therefore, in order to ensure that the second function task may be pulled up if the execution of the second function task is not completed and the second function task needs to continue to be executed, and improve the efficiency for managing the function tasks of the instant messaging application, the intelligent terminal may create the second task tab configured to pull up the second function task after switching the second function task to background, if receiving the designed operation based on the first task tab.

The intelligent terminal may pull up the second function task to switch the second function task to foreground if receiving the designed operation based on the second task tab.

It should be illustrated that, the second task tab may be created at any time before the intelligent terminal has switched the second function task to background, which is not specifically limited in the embodiments of the present disclosure.

It should be also illustrated that, after switching the second function task to background, the intelligent terminal may store status information of the second function task, such that the status information of the second function task may be read if pulling up the second function task, and the second function task may be pulled up according to the status information of the second function task.

Furthermore, as the instant messaging application installed on the intelligent terminal includes a plurality of functions, the intelligent terminal may also desire to create and execute other function tasks including the second function task when the intelligent terminal creates and executes the first function task. That is to say, in a same period of time, the intelligent terminal may alternately create and execute the plurality of function tasks, and then switch the plurality of function tasks to background, may create a plurality of task tabs that have been created for the plurality of function tasks of the instant messaging application in current.

It should be illustrated that, the intelligent terminal may display each task tab of the plurality of task tabs at the same time. Alternatively, the intelligent terminal may display some task tabs of the plurality of task tabs. For instance, the intelligent terminal may not display the task tab corresponding to the function task that is being executed and in foreground.

If the intelligent terminal displays each task tab of the plurality of task tabs at the same time, it may facilitate managing the plurality of task tabs and facilitate managing the plurality of function tasks of the instant messaging application, thereby improving the executing progress of the intelligent terminal. If the intelligent terminal displays some task tabs of the plurality of task tabs, it may enhance the displaying effect of the function task that is being executed currently and is in foreground, i.e. the efficiency of the function task that is being executed currently and is in foreground may be improved.

For instance, the intelligent terminal creates and executes the instant messaging task, the webpage surfing task and the paying task at the same period of time, and the intelligent terminal stores the task tab with “messaging” of the instant messaging task, the task tab with “webpage” of the webpage surfing task and the task tab with “paying” of the paying task. If the function task of the intelligent terminal in foreground currently is the instant messaging task, the intelligent terminal may display the task tabs with “messaging,” “webpages” and “paying” at the same time, or may merely display the task tabs with “webpage” and “paying.”

Furthermore, if displaying the plurality of task tabs, the intelligent terminal may display the plurality of task tabs in predetermined order to improve the efficiency for managing the function task of the instant messaging application.

The predetermined order may be an order that the plurality of function tasks are created, or may be an order that the plurality of function tasks are switched. Certainly, in the practical applications, the predetermined order may be other orders, which is not specifically limited in the embodiments of the present disclosure.

Furthermore, in order to improve the efficiency for managing the function tasks of the instant messaging application and to save the system resources of the intelligent terminal, the intelligent terminal may manage the plurality of task tabs to manage the plurality of function tasks if receiving the task tab managing instruction based on the plurality of task tabs.

The task tab managing instruction may be triggered by the user via a predetermined operation.

It should be illustrated that, the managing instruction may include a deleting instruction, a switching instruction and the like. Certainly, in the practical applications, the managing instruction may include other instructions, which is not specifically limited in the embodiments of the present disclosure.

For each task tab of the plurality of task tabs, if the managing instruction is the deleting instruction, the intelligent terminal may delete the task tab and the function task corresponding to the task tab; if the managing instruction is the switching instruction, the intelligent terminal may switch the function task corresponding to the task tab to foreground.

Furthermore, to facilitate creating a new task tab to create a new function task for the intelligent terminal, the intelligent terminal may display an empty tab which does not correspond to any one function task while displaying the plurality of task tabs, and the managing instruction may also include a creating instruction. When receiving the creating instruction based on the empty tab, the intelligent terminal may create a function task according to the creating instruction and may configure the empty tab as the task tab corresponding to the created function task.

In the embodiments of the present disclosure, during the process of executing the first function task of the instant messaging application, the intelligent terminal may switch the first function task to background if receiving the instruction for triggering the second function of the instant messaging application, and the intelligent terminal may store the status information of the first function task thereafter. The status information at least includes the executing progress of the first function task. And then, in order to pull up the first function task, the intelligent terminal may create the first function tab. In addition, the intelligent terminal may also create the second function task. Therefore it may not only ensure that the first function task is stored precisely before the second function task is created, but also ensure that the second function task is created and executed, thereby improving the efficiency of the intelligent terminal executing the plurality of function tasks at the same time. After creating the second function task, the intelligent terminal may pull up the first function task to switch the first function task to foreground if receiving the designed operation based on the first task tab. For each function task of the plurality of function tasks, the intelligent terminal may switch the function task to background, and may create the task tab for the function task, and also may store the status information of the function task. Therefore, the intelligent may pull up the function task quickly according to the task tab and the status information of the function task, if the function task needs to continue to be executed, thereby improving the efficiency for managing function tasks of the instant messaging application.

FIG. 6 is a block diagram illustrating an apparatus for managing a task of an instant messaging application according to an exemplary embodiment. Referring to FIG. 6, the apparatus includes a first switching module 601, a first creating module 602, a second creating module 603 and a second switching module 604.

The first switching module 601 is configured to, during a process of executing a first function task of the instant messaging application, switch the first function task to background if receiving an instruction for triggering a second function of the instant messaging application.

The first creating module 602 is configured to create a first task tab configured to pull up the first function task.

The second creating module 603 is configured to create a second function.

The second switching module 604 is configured to, after the second function task is created by the second creating module, pull up the first function task to switch the first function task to foreground if a designed operation is received based on the first task tab created by the first creating module.

In another embodiment of the present disclosure, the apparatus further includes: a hiding module configured to hide the first task tab during a process of executing the second function task; and a displaying module configured to display the first task tab hidden by the hiding module if a predetermined operation is received.

In another embodiment of the present disclosure, the apparatus further includes: a managing module configured to manage the plurality of task tabs if a task tab managing instruction is received based on a plurality of task tabs, and the plurality of task tabs are task tabs that have been created for a plurality of function tasks of the instant messaging application in current.

In another embodiment of the present disclosure, the apparatus further includes: a storing module configured to store status information of the first function task, and the status information of the first function task at least includes executing progress of the first function task.

In another embodiment of the present disclosure, the second switching module includes: a reading unit configured to after the second function task is created, read the status information of the first function task if the designed operation is received based on the first task tab; and a switching module configured to pull up the first function task to switch to the first function task to foreground according to the status information of the first function task.

In the embodiments of the present disclosure, the intelligent terminal, when executing the first function task of the instant messaging application and receiving the instruction for triggering the second function of the instant messaging application, the intelligent terminal may switch the first function task to background, and may also store the status information of the first function task thereafter. And then, in order to pull up the first function task, the intelligent terminal may also create the first task tab. In addition, the intelligent terminal may create the second function task. Therefore, it may not only ensure that the first function task is stored precisely before the second function task is created, but also ensure that the second function task is created and executed, thereby improving the efficiency of the intelligent terminal executing the plurality of function tasks at the same time. After creating the second function task, the intelligent terminal may pull up the first function task to switch the first function task to foreground if receiving the designed operation based on the first task tab. The embodiments of the present disclosure may pull up the first function after switching the first function task to background and creating the second function task, and further continue to execute the first function task, thereby improving the efficiency for managing the function tasks of the instant messaging application.

With respect to the apparatus in the above embodiment, the specific manners for executing operation for individual modules have been described in detail in the embodiments regarding the method, which is not elaborated in detail herein.

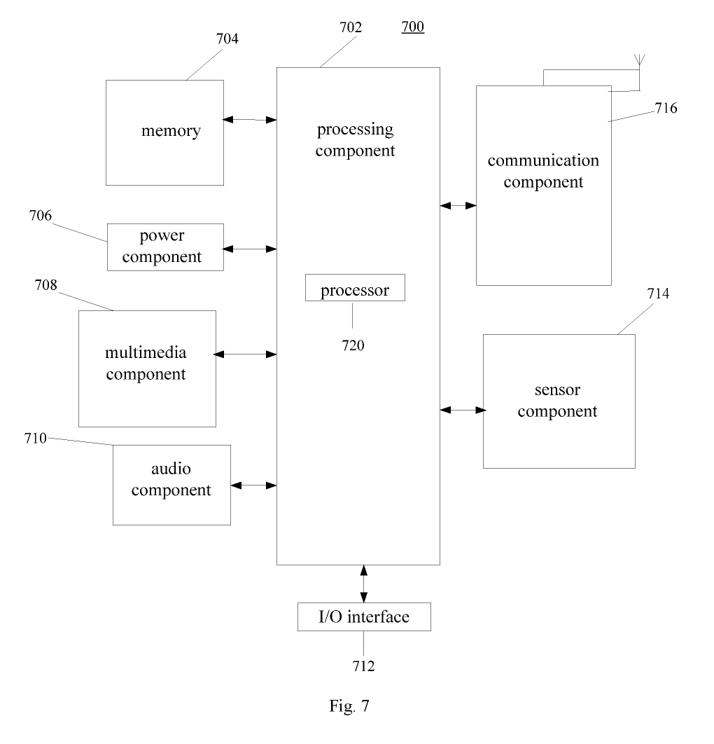

FIG. 7 is a block diagram illustrating another device 700 for managing a task of an instant messaging application according to an exemplary embodiment. For instance, the device 700 may be a mobile phone, a plate equipment, a personal digital assistant, or the like.

Referring to FIG. 7, the device 700 may include the following one or more components: a processing component 702, a memory 704, a power component 706, a multimedia component 708, an audio component 710, an Input/Output (I/O) interface 712, a sensor component 714, and a communication component 716.

The processing component 702 typically controls overall operations of the device 500, such as the operations associated with display, telephone calls, data communications, camera operations, and recording operations. The processing component 702 may include one or more processors 720 to execute instructions to execute all or parts of the acts in the above described methods. Moreover, the processing component 702 may include one or more modules which facilitate the interaction between the processing component 702 and other components. For instance, the processing component 702 may include a multimedia module to facilitate the interaction between the multimedia component 708 and the processing component 702.

The memory 704 is configured to store various types of data to support the operation of the device 700. Examples of such data include instructions for any applications or methods operated on the device 700, contact data, phonebook data, messages, pictures, video, etc. The memory 704 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 706 provides power to various components of the device 700. The power component 706 may include a power management system, one or more power sources, and any other components associated with the generation, management, and distribution of power in the device 700.

The multimedia component 708 includes a screen providing an output interface between the device 700 and the user. In some embodiments, the screen may include a liquid crystal display (LCD) and a press panel (TP). If the screen includes the press panel, the screen may be implemented as a press screen to receive input signals from the user. The press panel includes one or more press sensors to sense presses, swipes, and other gestures on the press panel. The press sensors may not only sense a boundary of a press or swipe action, but also sense a duration time and a pressure associated with the press or swipe action. In some embodiments, the multimedia component 708 includes a front camera and/or a rear camera. The front camera and/or the rear camera may receive external multimedia data while the device 700 is in an operation mode, such as a photographing mode or a video mode. Each of the front camera and the rear camera may be a fixed optical lens system or have focus and optical zoom capability.

The audio component 710 is configured to output and/or input audio signals. For instance, the audio component 710 includes a microphone (MIC) configured to receive an external audio signal if the device 700 is in an operation mode, such as a call mode, a recording mode, and a voice recognition mode. The received audio signal may be further stored in the memory 704 or transmitted via the communication component 716. In some embodiments, the audio component 710 further includes a speaker to output audio signals.

The I/O interface 712 provides an interface for the processing component 702 and peripheral interface modules, such as a keyboard, a click wheel, buttons, and the like. The buttons may include, but are not limited to, a home button, a volume button, a starting button, and a locking button.

The sensor component 714 includes one or more sensors to provide status assessments of various aspects of the device 700. For instance, the sensor component 714 may detect an open/closed status of the device 700 and relative positioning of components, such as the display and the keypad of the device 700. The sensor component 714 may also detect a change in position of the device 700 or of a component in the device 700, a presence or absence of user contact with the device 700, an orientation or an acceleration/deceleration of the device 700, and a change in temperature of the device 700. The sensor component 714 may include a proximity sensor configured to detect the presence of nearby objects without any physical contact. The sensor component 714 may also include a light sensor, such as a CMOS or CCD image sensor, for use in imaging applications. In some embodiments, the sensor component 714 may also include an accelerometer sensor, a gyroscope sensor, a magnetic sensor, a pressure sensor, or a temperature sensor.

The communication component 716 is configured to facilitate wired or wireless communication between the device 700 and other devices. The device 700 can access a wireless network based on a communication standard, such as WIFI, 2G, or 3G, or a combination thereof. In one exemplary embodiment, the communication component 716 receives a broadcast signal or broadcast associated information from an external broadcast management system via a broadcast channel. In one exemplary embodiment, the communication component 716 further includes a near field communication (NFC) module to facilitate short-range communications. For instance, the NFC module may be implemented based on a radio frequency identification (RFID) technology, an infrared data association (IrDA) technology, an ultra-wideband (UWB) technology, a Bluetooth (BT) technology, and other technologies.

In exemplary embodiments, the device 700 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for executing the above described methods.

In exemplary embodiments, there is also provided a non-transitory computer readable storage medium including instructions, such as the memory 704 including instructions. The above instructions are executable by the processor 720 in the device 700, for executing the above-described methods. For instance, the non-transitory computer-readable storage medium may be a ROM, a RAM, a CD-ROM, a magnetic tape, a floppy disc, an optical data storage device, and the like.

A non-transitory computer readable storage medium, if the instructions in the storage medium is executed by the processer in the mobile terminal, may allow the mobile terminal execute a method for managing a task of an instant messaging application, the method includes: during a process of executing a first function task of the instant messaging application, switching the first function task to background if an instruction for triggering a second function of the instant messaging application is received; creating a first task tab configured to pull up the first function task; creating a second function task; and after creating the second function task, pulling up the first function task to switch the first function task to foreground if a designed operation is received based on the first task tab.

In another embodiment of the present disclosure, after creating a first task tab, the method further includes: hiding the first task tab during a process of generating the second function task; displaying the first task tab if a predetermined operation is received.

In another embodiment of the present disclosure, the method further includes: if a task tab managing instruction is received based on a plurality of task tabs, managing the plurality of task tabs, and the plurality of task tabs are task tabs that have been created for a plurality of function tasks of the instant messaging application in current.

In another embodiment of the present disclosure, during a process of executing a first function task of the instant messaging application, switching the first function task to background if an instruction for triggering a second function of the instant messaging application is received. After the switch, the method further including: storing status information of the first function task, and the status information of the first function task at least includes the executing progress of the first function task.

In another embodiment of the present disclosure, after creating the second function task, pulling up the first function task to switch the first function task to foreground if a designed operation is received based on the first task tab includes: after creating the second function task, reading the status information of the first function task if the designed operation is received based on the first task tab; and pulling up the first function task to switch the first function task to foreground according to the status information of the first function task.

In the embodiments of the present disclosure, the intelligent terminal, when executing the first function task of the instant messaging application and receiving the instruction for triggering the second function of the instant messaging application, the intelligent terminal may switch the first function task to background, and may also store the status information of the first function task thereafter. And then, in order to pull up the first function task, the intelligent terminal may also create the first task tab. In addition, the intelligent terminal may create the second function task. Therefore, it may not only ensure that the first function task is stored precisely before the second function task is created, but also ensure that the second function task is created and executed, thereby improving the efficiency of the intelligent terminal executing the plurality of function tasks at the same time. After creating the second function task, the intelligent terminal may pull up the first function task to switch the first function task to foreground if receiving the designed operation based on the first task tab. The embodiments of the present disclosure may pull up the first function after switching the first function task to background and creating the second function task, and further continue to execute the first function task, thereby improving the efficiency for managing the function tasks of the instant messaging application.

Other embodiments will be apparent to those skilled in the art from consideration of the specification and practice of the invention disclosed here. This application is intended to cover any variations, uses, or adaptations of the invention following the general principles thereof and including such departures from the present disclosure as come within known knowledge or customary technical means in the art. It is intended that the specification and examples be considered as exemplary only, with a true scope and spirit of the invention being indicated by the following claims.

It should be understood that the present invention is not limited to the exact construction that has been described above and illustrated in the accompanying drawings, and that various modifications and changes can be made without departing form the scope thereof. It is intended that the scope of the invention only be limited by the appended claims.

What is claimed is:

1. A method for managing a task of an instant messaging application, applied in an intelligent terminal, the method comprising:
switching the first function task to background if an instruction for triggering a second function of the instant messaging application is received during a process of executing a first function task of the instant messaging application;
creating a first task tab configured to pull up the first function task;
creating a second function task; and
pulling up the first function task to switch the first function task to foreground if a designed operation is received based on the first task tab after creating the second function task.

2. The method according to claim 1, after creating a first task tab, further comprising:
hiding the first task tab during a process of executing the second function task; and
displaying the first task tab if a predetermined operation is received.

3. The method according to claim 1, further comprising:
managing a plurality of task tabs if a task tab managing instruction is received based on the plurality of task tabs, the plurality of task tabs being task tabs that have been created for a plurality of function tasks of the instant messaging application in current.

4. The method according to claim 1, after switching the first function task to background if an instruction for triggering a second function of the instant messaging application is received during a process of executing a first function task of the instant messaging application, further comprising:
storing status information of the first function task, the status information of the first function task at least comprising executing progress of the first function task.

5. The method according to claim 4, wherein pulling up the first function task to switch the first function task to foreground if a designed operation is received based on the first task tab after creating the second function task comprises:
reading the status information of the first function task if the designed operation is received based on the first task tab after creating the second function task; and
pulling up the first function task to switch the first function task to foreground according to the status information of the first function task.

6. A device for managing a task of an instant messaging application, comprising:
a processor; and
a memory, configured to store instructions executable by the processor,
wherein, the processor is configured to:
switch the first function task to background if an instruction for triggering a second function of the instant messaging application is received during a process of executing a first function task of the instant messaging application;
create a first task tab configured to pull up the first function task;
create a second function task; and
pull up the first function task to switch the first function task to foreground if a designed operation is received based on the first task tab after creating the second function task.

7. The device according to claim 6, wherein the processor is further configured to, after the first task tab is created,
hide the first task tab during a process of executing the second function task; and
display the first task tab if a predetermined operation is received.

8. The device according to claim 6, wherein the processor is further configured to:
manage a plurality of task tabs if a task tab managing instruction is received based on the plurality of task tabs, the plurality of task tabs being task tabs that have been created for a plurality of function tasks of the instant messaging application in current.

9. The device according to claim 6, after switching the first function task to background if an instruction for triggering a second function of the instant messaging application is received during a process of executing a first function task of the instant messaging application, wherein the processor is configured to:
store status information of the first function task, the status information of the first function task at least comprising executing progress of the first function task.

10. The device according to claim 9, wherein the processor is configured to pull up the first function task to switch the first function task to foreground if a designed operation is received based on the first task tab by acts of:
reading the status information of the first function task if the designed operation is received based on the first task tab; and
pulling up the first function task to switch the first function task to foreground according to the status information of the first function task.

11. A non-transitory computer-readable storage medium having stored therein instructions that, when executed by a processor of a terminal, causes the terminal to perform a method for managing a task of an instant messaging application, the method comprising:
switching the first function task to background if an instruction for triggering a second function of the instant messaging application is received during a process of executing a first function task of the instant messaging application;
creating a first task tab configured to pull up the first function task;
creating a second function task; and
pulling up the first function task to switch the first function task to foreground if a designed operation is received based on the first task tab after creating the second function task.

12. The non-transitory computer-readable storage medium according to claim 11, after creating a first task tab, the method further comprising:
hiding the first task tab during a process of executing the second function task; and
displaying the first task tab if a predetermined operation is received.

13. The non-transitory computer-readable storage medium according to claim 11, wherein the method comprises:
managing a plurality of task tabs if a task tab managing instruction is received based on the plurality of task tabs, the plurality of task tabs being task tabs that have been created for a plurality of function tasks of the instant messaging application in current.

14. The non-transitory computer-readable storage medium according to claim 11, wherein after switching the first function task to background if an instruction for triggering a second function of the instant messaging application is received during a process of executing a first function task of the instant messaging application, the method further comprises:
storing status information of the first function task, the status information of the first function task at least comprising executing progress of the first function task.

15. The non-transitory computer-readable storage medium according to claim 14, wherein pulling up the first function task to switch the first function task to foreground if a designed operation is received based on the first task tab after creating the second function task comprises:
reading the status information of the first function task if the designed operation is received based on the first task tab after creating the second function task; and
pulling up the first function task to switch the first function task to foreground according to the status information of the first function task.
